(19) United States
(12) Patent Application Publication
(10) Pub. No.: US 2024/0376770 A1
(43) Pub. Date: Nov. 14, 2024

(54) Protective Curtain and a Retractable Protective Door Railing with the Protective Curtain

(71) Applicant: Hongjuan WANG, Guangdong (CN)

(72) Inventor: Hongjuan WANG, Guangdong (CN)

(21) Appl. No.: 18/218,126

(22) Filed: Jul. 5, 2023

(30) Foreign Application Priority Data
May 8, 2023 (CN) 202321094095.9
May 29, 2023 (CN) 202321342092.2

(51) Int. Cl. E06B 9/08; E06B 7/32

(52) U.S. Cl. CPC E06B 9/08; E06B 7/32; E06B 2009/002

(57) ABSTRACT

The present utility model discloses a protective curtain and a retractable protective door railing with the protective curtain. The curtain body is provided with at least a reinforcing strip to improve the anti warping property of the curtain. When the protective curtain is in an unfolded state for use, the reinforcing strip that plays a role of structural reinforcement can significantly reduce or eliminate the degree of warping of protective curtain in use, as well as the possibility of a large passage between the warped middle part of curtain bottom and the ground, decrease or avoid the likelihood of children or pets going outside through the passage, thereby improving the protective property and overall aesthetic of the protective door railing.

### BACKGROUND OF THE INVENTION

The present utility model relates to the technical field of child protection products, in particular to a protective curtain, and a retractable protective door railing with the protective curtain.

In order to prevent infants and pets, when going outdoors, from getting lost or injured, protective door railings are often arranged at indoor doors, stairwells, or corridors, mainly including retractable protective door railings and non retractable protective door railings. The retractable protective door railing, for example, mainly includes roller shutter components, upper and lower fixed seats, roller shaft components, hooks, hook holders, etc. The protective curtain of the roller shutter component is connected to the roller shaft component and can be pulled out or automatically retracted through the roller shaft component. Warping will occur to the middle part of the bottom of protective curtains which are generally made of soft mesh fabric due to the individual or combined action of self gravity, self stress, or external forces. Generally, the longer the protective curtain, the more severe the warping it will suffer, which not only affects the overall aesthetic, but also results in a safety hazard when a large passage is formed between the warped part of the protective curtain and the ground because of significant warping, allowing children or pets to climb out and pass through.

### BRIEF SUMMARY OF THE INVENTION

To solve the shortcomings of prior art, the present utility model discloses a protective curtain and a retractable protective door railing with the protective curtain that can significantly reduce or eliminate the warping during the use of protective curtain, thereby improving the protective property and overall aesthetic of the protective door railing.

In order to address the aforementioned technical issues, the present utility model proposes a protective curtain for protecting door railing, comprising a curtain body that is provided with at least a reinforcing strip to improve the anti warping property of the curtain.

This present utility model also proposes a retractable protective door railing, including a protective curtain which is the above-mentioned protective curtain.

In the present utility model, the curtain body is provided with at least a reinforcing strip to improve the anti warping property of the curtain. When the protective curtain is in an unfolded state for use, the reinforcing strip that plays a role of structural reinforcement can significantly reduce or eliminate the degree of warping of protective curtain in use, as well as the possibility of a large passage between the warped middle part of curtain bottom and the ground, decrease or avoid the likelihood of children or pets going outside through the passage, thereby improving the protective property and overall aesthetic of the protective door railing.

### BRIEF DESCRIPTION OF THE DRAWINGS

FIG. 1 is a structural schematic diagram of the present utility model in an extended state.

FIG. 2 is a structural schematic diagram of the present utility model in a folded state;

FIG. 3 is a structural schematic diagram of the present utility model under local decomposition;

FIG. 4 is a structural schematic diagram of another embodiment of the present utility model.

### DETAILED DESCRIPTION OF THE INVENTION

The technical solutions in the embodiments of the present utility model will be described clearly and completely in conjunction with the accompanying drawings of the embodiments of the present utility model. Obviously, the described embodiments are only a part of the embodiments of the present utility model, rather than all the embodiments. Based on the embodiments of the present utility model, all other embodiments obtained by those of ordinary skill in the art without creative work shall fall within the protection scope of the present utility model.

It should be noted that all directional indicators (such as up, down, left, right, front, rear, etc.) in the embodiments of the present utility model are only used to explain the relative position relationship and movement among various components in a particular posture (as shown in the accompanying drawings), and if that particular posture is changed, the directional indications will change accordingly.

In addition, descriptions involving terms “first,” “second” and the like, if any, in the present utility model are only for illustrative purposes and cannot be understood as indicating or implying relative importance or the number of features referred to. Therefore, the features defined with “first” and “second” may explicitly or implicitly include at least a of the features. At the same time, the technical solutions of various embodiments can be combined with each other, but must be based on what those of ordinary skill in the art can achieve. The combination of technical solutions that result in contradiction or make it impossible to implement should be considered non-existent, and accordingly should not fall within the scope of protection required by this present utility model.

The present utility model proposes a protective curtain for protecting door railings.

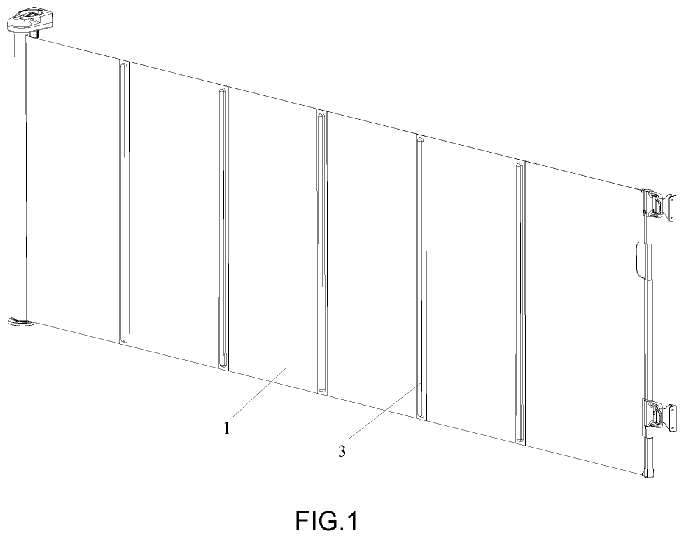

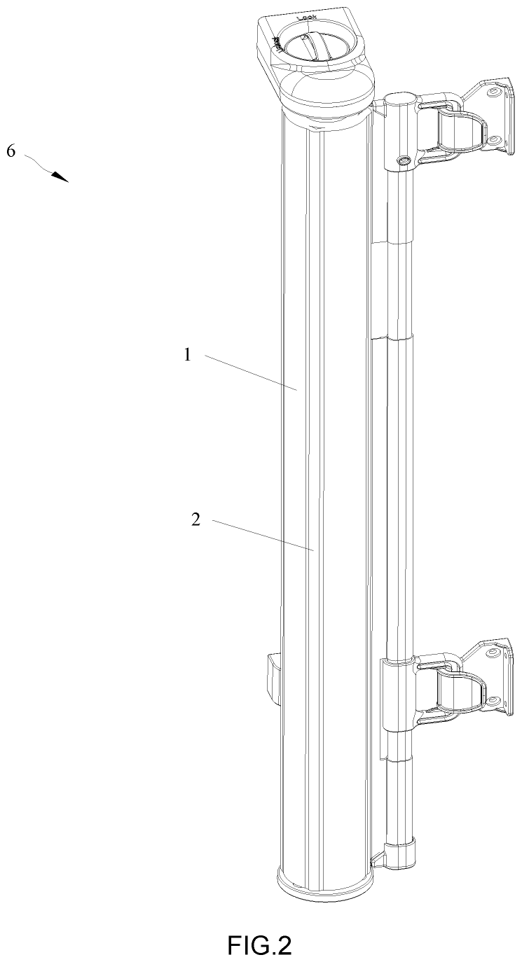

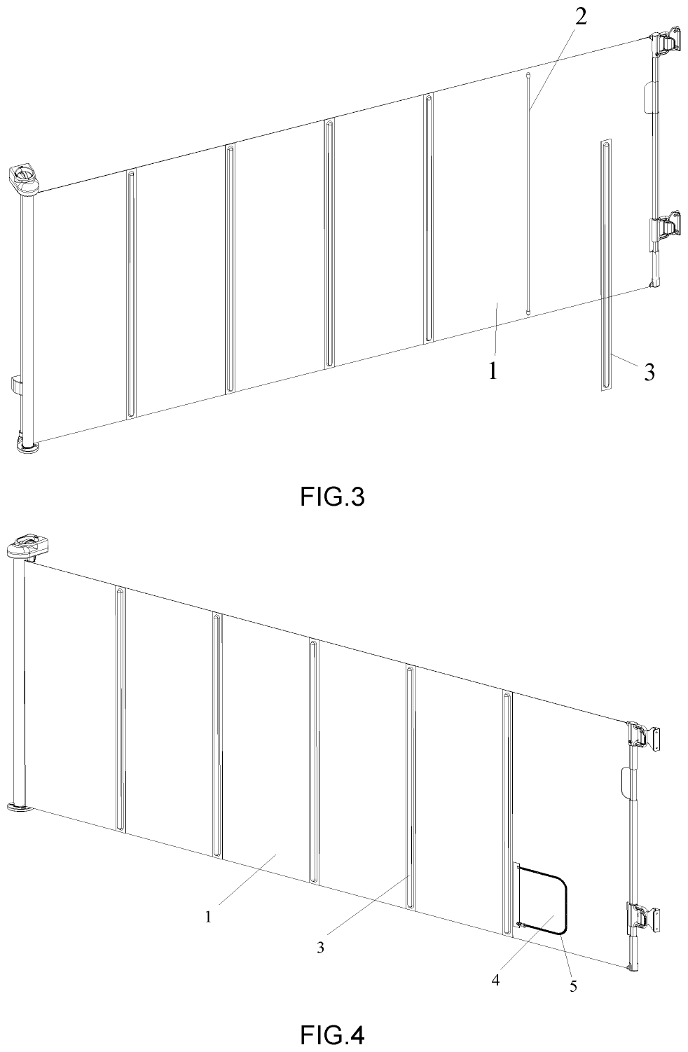

In the embodiment of present utility model, as shown in FIG. 1 to FIG.4, the protective curtain includes a curtain body 1, and the curtain body 1 is provided with at least a reinforcing strip 2 to improve the anti warping property of the curtain 1. When the protective curtain is in an unfolded state for use, the reinforcing strip that plays a role of structural reinforcement can significantly reduce or eliminate the degree of warping of protective curtain in use, as well as the possibility of a large passage between the warped middle part of curtain 1 bottom and the ground, decrease or avoid the likelihood of children or pets going outside through the passage, thereby improving the protective property and overall aesthetic of the protective door railing.

Specifically, there are a plurality of reinforcing strips 2, which are spaced along the length direction (or horizontally) of the curtain body 1. This distribution allows to divide curtain body 1 into a plurality of regions along its length direction, and each region of curtain body 1 is structurally reinforced by the reinforcing strips 2 to improve its anti warping property.

Understandably, the number of reinforcing strips 2 can be set as needs, such as the length of curtain body 1 and the required anti warping strength. Generally, the more the reinforcing strips there are, the stronger the anti warping property, but the higher the production cost and weight.

Specifically, a plurality of reinforcing strips 2 extend vertically or diagonally upwards from the bottom of the curtain body 1, increasing the strength of the bottom of curtain body 1.

Preferably, the bottom end of reinforcing strips 2 extend vertically or obliquely upwards at a position that is flush with or close to the bottom edge of the curtain body 1, to a position that is flush with or close to the top edge of the curtain body 1, in order to improve the overall aesthetics and anti warping property.

Specifically, the reinforcing strips are thin straight strips, thin curved strips, slender L-shaped, or “X” shaped.

Understandably reinforcing strips 2 may have a plurality of examples, such as thin straight strips, thin curved strips, slender L-shaped, or an “X” shaped, etc. The cross-sectional area can be circular, triangular, rectangular, elliptical, etc. Selection can be made specifically based on the actual needs, and thin straight strips are preferred in this embodiment.

Specifically, the reinforcing strips 2 are made of hard materials. The reinforcement strips 2 made of hard materials can effectively improve the overall structural strength of curtain body 1 and ensure its anti warping property.

Exemplarily, hard materials can be at least a of the engineering plastics, polymer materials, glass fibers, carbon fibers, or acrylic materials, preferably the glass fibers which allow for better balance among strength, cost, and aesthetics.

Specifically, at least a reinforcing strip 2 is disposed at the bottom of the curtain body 1 and extends along the length direction of the curtain body 1. The reinforcing strip that structurally reinforces the bottom of curtain body 1 helps improve the anti warping property of the bottom of curtain body 1.

Specifically, a plurality of reinforcing strips 2 are spaced vertically and extend along the length direction of the curtain body 1.

Understandably, for non retractable protective door railings, reinforcing strips 2 can be made of hard materials, such as the engineering plastics, polymer materials, glass fibers, carbon fibers, or acrylic materials, preferably the glass fibers which allow for better balance among strength, cost, and aesthetics.

Specifically, in the embodiment, the reinforcing strips 2 are made of plastic or metal thin sheets. For retractable protective door railings, for example, the reinforcement strips 2 made of hard materials that extend horizontally will hinder the normal retrieval of curtain body 1. Therefore, in this regard, the reinforcing strips in this embodiment should allow for both strength and curlability, for example, it can be made of slightly soft plastic or metal sheets.

Understandably, a plurality of ways are available to dispose reinforcing strips 2 on the curtain body 1, for example, the reinforcing strips 2 can be fixed onto the curtain body 1 through adhesive, screw structure, binding, or a wrapping layer 3. The process of fixing reinforcing strips 2 through adhesive, screw structure, and binding, which can be realized by prior art, is not elaborated here.

Specifically, a plurality of ways are available to fix reinforcing strips 2 onto the curtain body 1 using the wrapping layer 3, for example, when there are a plurality of reinforcing strips 2, the wrapping layer 3 is an integrated structure that covers and fixes all the reinforcing strips 2 together on the surface of the curtain body 1, alternatively, each reinforcing strip 2 is separately covered and fixed on a split structure on the surface of the curtain body 1, alternatively when the number of wrapping layers 3 is less than that of reinforcing strips 2, at least a wrapping layer 3 covers and fixes a plurality of reinforcing strips 2. Selection can be made specifically based on factors such as usage and production cost. A wrapping layer 3 of integrated structure that covers and fixes all the reinforcing strips 2 together on the surface of curtain body 1 provides the protective curtain with good integrity and structural strength. The wrapping layer of split structure that covers and fixes each reinforcing strip 2 on the surface of curtain body 1 has a lower production cost. When there are a plurality of wrapping layers but its number is less than that of reinforcing strips 2, and at least a wrapping layer 3 covers and fixes a plurality of reinforcing strips 2, the cost and structural strength can be balanced to some extent.

Specifically, the wrapping layer 3 is fixed onto the surface of the curtain body 1 by adhesive, screw structure, binding or stitching. The process of fixing wrapping layer 3 through adhesive, screw structure, and binding, which can be realized by prior art, is not elaborated here.

Specifically, as shown in FIG. 4, a passage (not indicated) is provided near the bottom of the curtain body for pets to enter and exit, and a passage door 4 is provided to control the closing and opening of the passage. Pets can freely pass through the passage when it is open, but they are not allowed to pass through the passage when it is closed (see FIG. 4).

Specifically, the passage door 4 is structurally integrated with or separately from the curtain body 1. For an integrated structure, the passage door 4 is directly cut from curtain body 1, with one side connected to curtain body 1. This structure allows for lower production cost, convenient opening and closing, and also prevents the loss of passage door 4.

Specifically, the passage door 4 is connected to the curtain body 1 through a chain structure 5, Velcro or buckle structure, controlling the opening or closing of the passage.

The present utility model also proposes a retractable protective door railing 6 that includes a protective curtain. The specific structure of the protective curtain is detailed in the above embodiment. The retractable protective door railing, thanks for integrating all the technical solutions of the above protective curtain, has at least all the beneficial effects from the technical solutions of the above protective curtain, which will not be elaborated here. Understandably, retractable protective door railing can also include upper and lower fixed seats, roller shafts, and other components, which are well-known to the person skilled in the art. The specific structure, connection relationship, and working principle of the above components will not be elaborated here.

The above are only the preferred embodiments of the present utility model, and are not intended to limit the present utility model. Any equivalent structural transformation made based on the description and accompanying drawings hereof under the concept of present utility model, or be directly/indirectly applied in other related technical fields, should fall within scope of patent protection of the present utility model.

What is claimed is:

1. A protective curtain for protecting door railing, comprising a curtain body (1), wherein the curtain body (1) is provided with at least a reinforcing strip (2) to improve the anti warping property of the curtain (1).

2. The protective curtain according to claim 1, wherein a plurality of reinforcing strips (2) are spaced along the length direction of the curtain body (1).

3. The protective curtain according to claim 2, wherein multiple a plurality of reinforcing strips (2) extend vertically or diagonally upwards from the bottom of the curtain body (1).

4. The protective curtain according to claim 2, wherein the reinforcing strips (2) are thin straight strips, thin curved strips, slender L-shaped, or “X” shaped.

5. The protective curtain according to claim 2, wherein the reinforcing strips (2) are made of hard materials.

6. The protective curtain according to claim 1, wherein at least a reinforcing strip (2) is disposed at the bottom of the curtain body (1) and extends along the length direction of the curtain body (1).

7. The protective curtain according to claim 6, wherein a plurality of reinforcing strips (2) are spaced vertically and extend along the length direction of the curtain body (1).

8. The protective curtain according to claim 7, wherein the reinforcing strips (2) are made of plastic or metal thin sheets.

9. The protective curtain according to claim 1, wherein the reinforcing strips (2) are fixed onto the curtain body (1) through adhesive, screw structure, binding, or a wrapping layer (3).

10. The protective curtain according to claim 9, wherein when there are a plurality of reinforcing strips (2), the wrapping layer (3) is an integrated structure that covers and fixes all the reinforcing strips (2) together on the surface of the curtain body (1), alternatively, each reinforcing strip (2) is separately covered and fixed on a split structure on the surface of the curtain body (1), alternatively when the number of wrapping layers (3) is less than that of reinforcing strips (2), at least a wrapping layer (3) covers and fixes a plurality of reinforcing strips (2).

11. The protective curtain according to claim 10, wherein the wrapping layer (3) is fixed onto the surface of the curtain body (1) through adhesive, screw structure, binding or stitching.

12. The protective curtain according to claim 1, wherein a passage is provided near the bottom of the curtain body (1) for pets to enter and exit, and a passage door (4) is provided to control the closing and opening of the passage.

13. The protective curtain according to claim 12, wherein the passage door (4) is structurally integrated with or separately from the curtain body (1).

14. The protective curtain according to claim 12, wherein the passage door (4) is connected to the curtain body (1) through a chain structure (5), Velcro or buckle structure.

15. A retractable protective door railing, wherein it includes the protective curtain as claimed in claim 1.

16. A retractable protective door railing according to claim 15, wherein a plurality of reinforcing strips (2) are spaced along the length direction of the curtain body (1).

17. A retractable protective door railing according to claim 16, wherein a plurality of reinforcing strips (2) extend vertically or diagonally upwards from the bottom of the curtain body (1).

18. A retractable protective door railing according to claim 15, wherein at least a reinforcing strip (2) is disposed at the bottom of the curtain body (1) and extends along the length direction of the curtain body (1).

19. A retractable protective door railing according to claim 15, wherein a passage is provided near the bottom of the curtain body (1) for pets to enter and exit, and a passage door (4) is provided to control the closing and opening of the passage.

20. A retractable protective door railing according to claim 19, wherein the passage door (4) is structurally integrated with or separately from the curtain body (1).
